(19) United States
(12) Patent Application Publication
(10) Pub. No.: US 2024/0330565 A1
(43) Pub. Date: Oct. 3, 2024

(54) PAGE LOADING METHOD AND APPARATUS, ELECTRONIC DEVICE, AND STORAGE MEDIUM

(71) Applicant: BEIJING ZITIAO NETWORK TECHNOLOGY CO., LTD., Haidian District (CN)

(72) Inventors: Tao CHENG, Beijing (CN); Long ZHANG, Beijing (CN)

(21) Appl. No.: 18/620,620

(22) Filed: Mar. 28, 2024

(30) Foreign Application Priority Data
Mar. 29, 2023 (CN) 202310324095.1

(51) Int. Cl. G06F 40/106; G06F 40/117

(52) U.S. Cl. CPC G06F 40/106; G06F 40/117

(57) ABSTRACT

Embodiments of the present disclosure provide a page loading method and apparatus, an electronic device, and a storage medium. The method includes: acquiring attribute information of a target page, which characterizes a page layout of the target page; obtaining, in accordance with the attribute information, a corresponding target constructor which has an attribute parameter for receiving the attribute information; and constructing a target view object in accordance with the target constructor and the attribute information, and displaying the target page based on the target view object.

### CROSS-REFERENCE TO RELATED APPLICATIONS

The present disclosure is based on and claims priority to China Patent Application No. 202310324095.1 filed on Mar. 29, 2023 and entitled as “page loading method and apparatus, electronic device, and storage medium”, the disclosure of which is incorporated by reference herein in its entirety.

### TECHNICAL FIELD

The present disclosure relates to the field of computer technologies, and in particular, to a page loading method and apparatus, an electronic device, and a storage medium.

### BACKGROUND

In the Android operating system, a page layout in an application (APP) can be described by a layout file, and therefore before a page in the APP is displayed, a terminal device needs to load the layout file first, and then determine a view in the page based on layout information in the layout file, thereby displaying the page.

However, the process of loading the layout file is time-consuming and affects page display speed; in order to solve the time-consuming problem caused by loading the layout file, in the related art, the layout file is translated into program code in advance and the program code is compiled into the APP, and when the APP is running, display of a target page is achieved by loading program code corresponding to the target page, thereby increasing the page display speed.

However, in the related art, after the layout file is translated into the program code of the target page in advance, problems of poor compatibility and inefficient operation occur in the process of loading the target page.

### SUMMARY

An embodiment of the present disclosure provides a page loading method and apparatus, an electronic device, and a storage medium, so as to overcome the problems of poor compatibility and inefficient operation in loading a target page in the related art.

In a first aspect, an embodiment of the present disclosure provides a page loading method, comprising:
acquiring attribute information of a target page, which characterizes a page layout of the target page; obtaining, in accordance with the attribute information, a corresponding target constructor which has an attribute parameter for receiving the attribute information; and constructing a target view object in accordance with the target constructor and the attribute information, and displaying the target page based on the target view object.

In a second aspect, an embodiment of the present disclosure provides a page loading apparatus, comprising:
an acquiring module configured to acquire attribute information of a target page, which characterizes a page layout of the target page;
a processing module configured to obtain, in accordance with the attribute information, a corresponding target constructor which has an attribute parameter for receiving the attribute information; and
a displaying module configured to construct a target view object in accordance with the target constructor and the attribute information, and display the target page based on the target view object.

In a third aspect, an embodiment of the present disclosure provides an electronic device, comprising:
a processor, and a memory communicatively connected with the processor,
wherein the memory stores computer executable instructions; and
the processor executes the computer executable instructions stored in the memory, to implement the page loading method in accordance with the first aspect and various possible designs of the first aspect.

In a fourth aspect, an embodiment of the present disclosure provides a non-transitory computer-readable storage medium having therein stored computer executable instructions which, when executed by a processor, implement the page loading method in accordance with the first aspect and various possible designs of the first aspect.

In a fifth aspect, an embodiment of the present disclosure provides a computer program product comprising a computer program which, when executed by a processor, implements the page loading method in accordance with the first aspect and various possible designs of the first aspect.

### BRIEF DESCRIPTION OF THE DRAWINGS

In order to more clearly illustrate the technical solutions in the embodiments of the present disclosure or the related art, the drawings that need to be used in the description of the embodiments or the related art will be briefly described below, and it is apparent that the drawings in the following description are some embodiments of the present disclosure, and for one of ordinary skill in the art, other drawings can also be obtained in accordance with these drawings without paying out creative efforts.

FIG. 1 is an application scenario diagram of a page loading method provided in an embodiment of the present disclosure;

FIG. 2 is a first schematic flow diagram of a page loading method provided in an embodiment of the present disclosure;

FIG. 3 is a schematic flow diagram of generating attribute information of a target page provided in an embodiment of the present disclosure;

FIG. 4 is a second schematic flow diagram of a page loading method provided in an embodiment of the present disclosure;

FIG. 5 is a schematic flow diagram of generating a layout data object provided in an embodiment of the present disclosure;

FIG. 6 is a flow diagram of a specific implementation of step S202 in the embodiment shown in FIG. 4;

FIG. 7 is a schematic diagram of generating sub-layout data objects provided in this embodiment;

FIG. 8 is a flow diagram of another specific implementation of step S202 in the embodiment shown in FIG. 4;

FIG. 9 is another schematic diagram of generating sub-layout data objects provided in this embodiment;

FIG. 10 is a flow diagram of a specific implementation of step S203 in the embodiment shown in FIG. 4;

FIG. 11 is a structural block diagram of a page loading apparatus provided in an embodiment of the present disclosure;

FIG. 12 is a structural schematic diagram of an electronic device provided in an embodiment of the present disclosure; and

FIG. 13 is a hardware structural schematic diagram of an electronic device provided in an embodiment of the present disclosure.

### DETAILED DESCRIPTION

To make the objectives, technical solutions and advantages of the embodiments of the present disclosure more apparent, the technical solutions in the embodiments of the present disclosure will be described clearly and completely blow with reference to the drawings in the embodiments of the present disclosure, and it is apparent that the described embodiments are some embodiments of the present disclosure, rather than all embodiments. All other embodiments, which are obtained by one of ordinary skill in the art based on the embodiments in the present disclosure without making creative efforts, are intended to fall within the scope of protection of the present disclosure.

It should be noted that, user information (including but not limited to user equipment information, user personal information, etc.) and data (including but not limited to data for analysis, stored data, displayed data, etc.) involved in the present disclosure are all information and data authorized by users or fully authorized by all parties, and collection, use and processing of relevant data need to comply with relevant laws and regulations and standards in relevant countries and regions, and are provided with corresponding operation entries for the users to select authorization or denial.

In accordance with the page loading method and apparatus, the electronic device, and the storage medium provided in the embodiments, attribute information of a target page is acquired, which characterizes a page layout of the target page; a corresponding target constructor is obtained in accordance with the attribute information, which has an attribute parameter for receiving the attribute information; and a target view object is constructed in accordance with the target constructor and the attribute information, and the target page is displayed based on the target view object. In the process of loading the target page, the target view object is constructed by using the target constructor having the attribute parameter, and page loading is made based on the target view object, thereby displaying the target page, so that the page layout of the target page can be automatically adapted through the attribute parameter of the target constructor, without the need of artificial adaptation in advance, loading efficiency and compatibility of the target view object are improved and use cost is reduced.

An application scenario of the embodiments of the present disclosure is explained below:

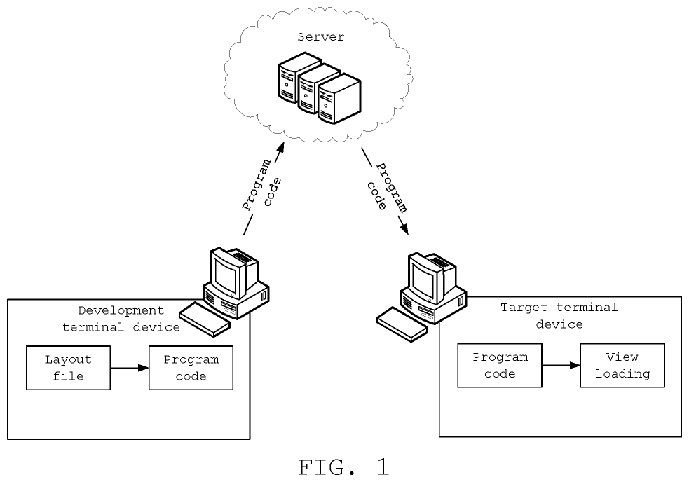

FIG. 1 is an application scenario diagram of a page loading method provided in an embodiment of the present disclosure, which may be applied into scenarios such as application (APP) development and testing and APP running. Specifically, as shown in FIG. 1, the method provided in the embodiment of the present disclosure may be applied to a target terminal device, for example, a personal computer. As shown in the figure, after a program developer designs a page layout in an APP based on specific requirements of program development, a layout file (for example, an extensible markup language file) characterizing the page layout is generated, then the layout file is parsed by a development terminal device and compiled together with other data and files for implementing functions of the APP, to generate program code of the APP (including, for example, an installation file, an executable file, a dynamic link library, etc. of the APP), and then the program code of the APP is sent to a server for the target terminal device (other user) to download and run. In the process of running the APP in the target terminal device, when it is needed to load the page layout, attribute information in the program code characterizing the page layout of a target page can be directly acquired, and view loading is made based on the attribute information, without the need of obtaining the layout information by reading the layout file, thereby achieving the purpose of improving the page loading speed. Of course, in other possible implementations, the above process of generating the program code of the target program may also be performed on the server side, and in such a case, after receiving necessary input data and instructions, the server performs the above method of generating the installation program of the APP, and other processing steps are similar, which will not be repeated.

In the related art, taking the Android operating system as an example, in the above solution of converting the layout file into program code (i.e., Java Code) and compiling and packaging the program code to generate a program file, the time-consuming problem of page loading caused by the loading of the layout file can be solved. However, there will be a compatibility problem in this solution, because: in the related art, after a target terminal device determines a target page to be displayed by running program code, it creates a view object in the target page first, and then sets an attribute of the view object, and meanwhile, when constructing the view object, a constructor with only one parameter is used, so that such an implementation results in a need for pre-adaptation of the attribute of the view object to parse information for describing a view style and position. However, the attribute of the view object is personalized information set by a user as needed, so that artificial adaptation is required before the setting, and parsing is impossible without the adaptation. Even considering the attributes of the view objects provided by the system, it is also in a too huge quantity to achieve global adaptation, and as for a customized view object, adaptation can be made only based on a secondary development, thereby resulting in the compatibility problem.

An embodiment of the present disclosure provides a page loading method to solve the above problem.

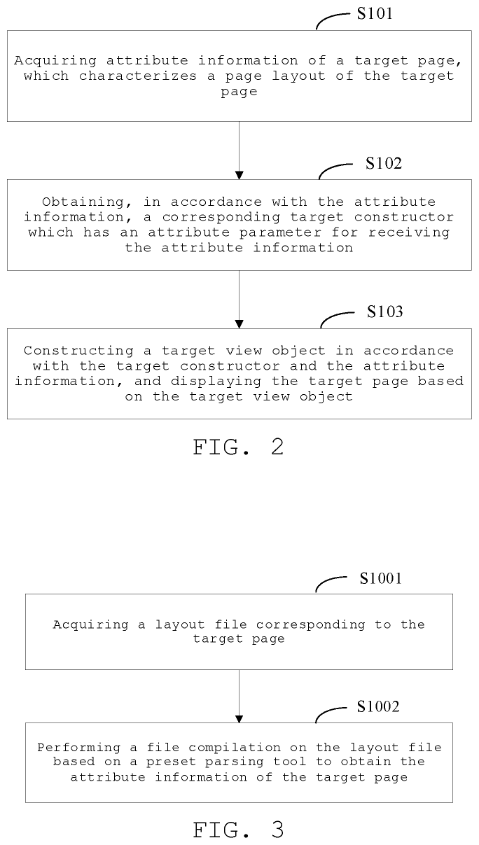

Reference is made to FIG. 2, which is a first schematic flow diagram of a page loading method provided in an embodiment of the present disclosure. The method of this embodiment can be applied to a terminal device, a server, or other electronic devices capable of realizing similar functions. The page loading method comprises:
step S101: acquiring attribute information of a target page, which characterizes a page layout of the target page.

Exemplarily, a target program refers to a specific APP, for example, a live APP (i.e., a live streaming/broadcasting APP), a short video APP, an instant messaging APP, and the like, and a target page refers to a specific page in the target program, for example, a homepage, a live page, and the like. Attribute information of the target page characterizes the page layout of the target page, and the attribute information is pre-stored in the APP by determining the layout file and compiling it and then pre-storing it in a form of program code. Reference may be made to the application scenario diagram shown in FIG. 1 for specific implementations, which will not be repeated here. Further, the layout file is, for example, an extensible markup language (XML) file, wherein the target program includes a plurality of pages for realizing different functions, each page corresponding to a different page layout, accordingly, exemplarily, each page in the target program has corresponding attribute information.

Further, in the target page of the target program, a view object is contained. The view object, which corresponds to a visual area on a screen, is responsible for displaying one area and responding to an event within this area. Common view objects are, for example, TextView, ImageView, Button, Linearlayout, RelativeLayout, and the like, and a specific definition of the view object may be recorded in the layout file, for achieving the description of the page layout.

Further, in an application scenario of testing the target program, the step of acquiring attribute information of a target page and a step of generating the attribute information of the target page may be completed on a same device (for example, the development terminal device shown in FIG. 1). That is, before the step S101, a step of compiling the target program in accordance with the layout file to generate corresponding program code including the attribute information of the target page, is further included. FIG. 3 is a schematic flow diagram of generating attribute information of a target page provided by an embodiment of the present disclosure, and as shown in FIG. 3, before the step S101, the method further includes:
step S1001: acquiring a layout file corresponding to the target page.

Step S1002: performing a file compilation on the layout file based on a preset parsing tool to obtain the attribute information of the target page.

Exemplarily, first, in accordance with specific content in a layout file, a corresponding parsing tool is obtained. In one possible implementation, the layout file is an XML file, and a corresponding parsing tool is selected in accordance with a size of the XML file, or the number of definitions of views included in the XML file and complexity of information, so that a volume of the parsing tool is matched with a volume of the XML file, to avoid the occurrence of a situation that a complex parsing tool is loaded to compile a simple layout file. Thus compiling efficiency is improved and a time consumed by the compiling is reduced. In another possible implementation, the layout file is parsed by using a preset parsing tool, wherein exemplarily, the parsing tool is an Android Asset Packaging Tool (aapt). More specifically, the Android Asset Packaging Tool includes an aapt and an aapt2, so that by means of the Android Asset Packaging Tool, resources can be parsed, indexed, and compiled into data in a binary format that is optimized for an Android platform, that is, in a compiling period for the layout file, resources in the layout file are parsed and converted into a data structure more suitable for reading in the Android platform, and each resource is indexed, ensuring that the resources in the layout file can be acquired and parsed as fast as possible in operation. Therefore, by performing a file compilation on the layout file through the parsing tool, the attribute information in the binary format can be acquired. The Android Asset Packaging Tools aapt and aapt2 are known to those skilled in the related art, so that it will not be described here.

Step S102: obtaining, in accordance with the attribute information, a corresponding target constructor (or a constructing function) which has an attribute parameter for receiving the attribute information.

Exemplarily, the target constructor refers to a constructor for constructing the view object within the target page. For example, the target constructor is a constructor of the view object, and the attribute parameter of the target constructor is a custom attribute. The constructor of the view object in the Android operating system includes at least two implementations which respectively correspond to two different construction methods. The at least two implementations include a constructor containing only one parameter and a constructor containing two parameters. More specifically, the constructor containing one parameter is illustrated as:
view (context); and
   the constructor containing two parameters is illustrated as:
view (context, AttributeSet).

The first constructor containing one parameter, that is a solution in the related art, is used when a view object is created through Java code, which requires pre-adaptation of an attribute of the view object. However, the second constructor containing two parameters can create a view object through information in the layout file. Here, context is a page parameter for indicating the target page, and AttributeSet is an attribute parameter for receiving the attribute information, that is, the target constructor obtains information characterizing the page layout (attribute information) through AttributeSet, to create a corresponding view object from the information characterizing the page layout, thereby mapping and converting the layout file to the view object.

Further, after the attribute information is obtained, since the attribute information is obtained based on the layout file, it is determined that the corresponding target constructor is the constructor containing the following two parameters: the page parameter (context) and the attribute parameter (AttributeSet).

Step S103: constructing a target view object in accordance with the target constructor and the attribute information, and displaying the target page based on the target view object.

Exemplarily, after the target constructor is determined, the attribute information is inputted as input information into the target constructor, that is, the attribute information is received through the attribute parameter, and the target constructor is called to perform a corresponding construction method, to generate a corresponding target view object in a memory. The target view object is one or more views, i.e. ViewTree, that meet the requirements of the page layout characterized by the attribute information. Further, by performing view rendering through the ViewTree created in the above step, content in the target page can be displayed. The specific implementation principle and manner of displaying the content in the target page based on the ViewTree are existing technologies in the Android operating system, and will not be described here.

In this embodiment, attribute information of a target page is acquired, which characterizes a page layout of the target page; in accordance with the attribute information, a corresponding target constructor which has an attribute parameter for receiving the attribute information is obtained; and a target view object is constructed in accordance with the target constructor and the attribute information, and the target page is displayed based on the target view object. In the process of loading the target page, the target view object is constructed by using the target constructor having the attribute parameter, and page loading is made based on the target view object, thereby displaying the target page, so that the page layout of the target page can be automatically adapted through the attribute parameter of the target constructor, without the need of artificial adaptation in advance, loading efficiency and compatibility of the target view object are improved and use cost is reduced.

Reference is made to FIG. 4, which is a second schematic flow diagram of a page loading method provided in an embodiment of the present disclosure. This embodiment further refines the step S103 on the basis of the embodiment shown in FIG. 2. The method comprises:

step S200: acquiring attribute information of a target page, which characterizes a page layout of the target page.

Step S201: obtaining, in accordance with the attribute information, a corresponding target constructor which has an attribute parameter for receiving the attribute information.

Step S202: creating, in accordance with the attribute information, a layout data object with a first data format, which is used for characterizing an overall layout of view objects within the target page.

Exemplarily, in the embodiment shown in FIG. 2, the specific implementation of the attribute information of the target page has been discussed, so that it will not be repeated here. After the attribute information is acquired, a corresponding target constructor having an attribute parameter is selected, wherein the target constructor is, for example: View (para_1, para_2), para_1 being a page parameter indicating the target page, and para_2 being an attribute parameter for receiving the attribute information, and more specifically, in the constructor for View in the Android operating system, para_1 being context, and para_2 being AttributeSet.

Further, a layout data object is created in accordance with the attribute information, wherein exemplarily, the layout data object is obtained based on an XMLBlock class. More specifically, the layout data object is an instantiation object of XMLBlock, which is shown as, for example, XmlBlock. The first data format is a data format the XMLBlock class has, and the layout data object, which is used for characterizing the overall layout of the view objects within the target page, is the equivalent of a container for containing the attribute information but has a certain first data format, so that with the help of the layout data object, a format conversion from the attribute information generated by XML to the attribute parameter is achieved. The XMLBlock (extensible Markup Language Block) is a modular tool for XML file editing, and the XMLBlock can help a developer to separate different elements in an XML file for detailed editing and management. The specific implementation principles and usage methods thereof are existing technologies, and will not be described here.

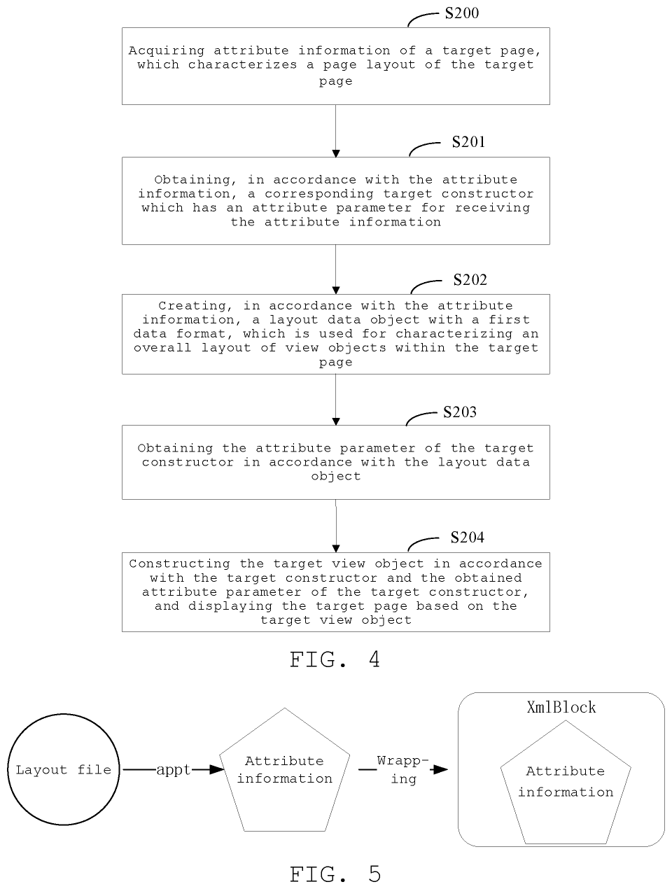

FIG. 5 is a schematic flow diagram of generating a layout data object based on attribute information provided in an embodiment of the present disclosure. As shown in FIG. 5, after a layout file in an XML format is compiled by using the Android Asset Packaging Tool appt or appt2 (shown as appt in the figure), binary data, i.e., the attribute information, is obtained, then a terminal device that performs the method of this embodiment wraps the binary attribute information to obtain the attribute information which is based on the layout data object XmlBlock (create the layout data object), i.e., binary data wrapped in the XmlBlock (layout data object). The binary data wrapped in the XmlBlock can characterize the overall layout of the view objects within the target page.

Further, in an actual application process, the attribute information characterizes the overall layout of the view objects within the target page, that is, a plurality of view objects are generally included within the target page, and at this time, in order to characterize features of the view objects within the target page, the attribute information needs storing view information corresponding to the view objects, wherein the view information is information characterizing a specific style, position, and attribute of the view object. For example, if a target page includes 8 view objects, the attribute information corresponding to the target page needs storing view information respectively corresponding to the 8 view objects. In order to improve loading speed of the view objects in the target page subsequently, in this embodiment, view information of different view objects in the attribute information is independently stored in the process of generating the layout data object, thereby improving the speed of loading and displaying the view objects within the target page subsequently.

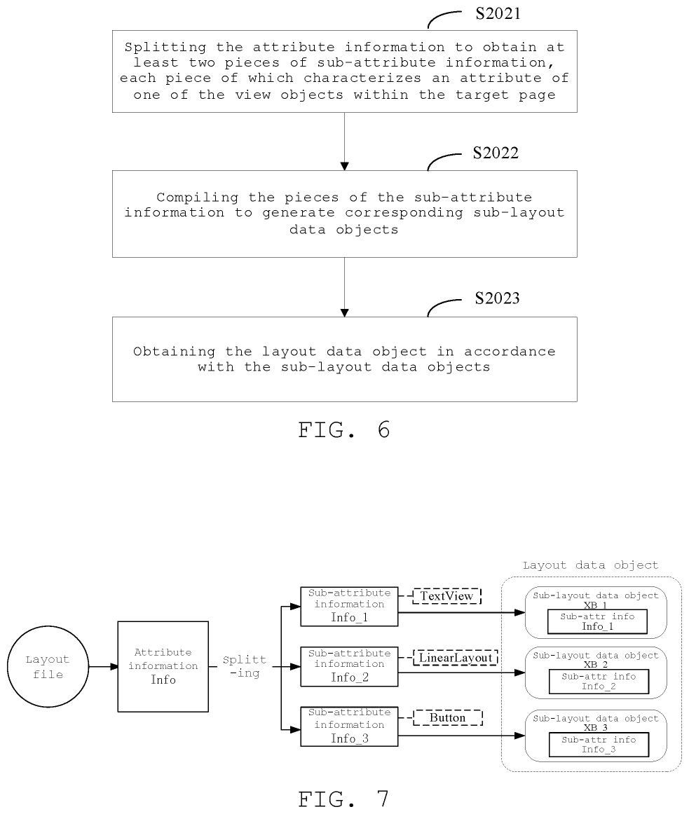

Specifically, in one possible implementation, as shown in FIG. 6, one possible implementation of the step S202 comprises:

step S2021: splitting the attribute information to obtain at least two pieces of sub-attribute information, each piece of which characterizes an attribute of one of the view objects within the target page.

Step S2022: compiling the pieces of the sub-attribute information to generate corresponding sub-layout data objects.

Step S2023: obtaining the layout data object in accordance with the sub-layout data objects.

Exemplarily, after attribute information in a binary data format is obtained, the attribute information is split into pieces of sub-attribute information in a quantity equal to that of view objects based on a specific data split rule, each of the pieces of the sub-attribute information characterizing an attribute of one of the view objects within a target page, that is, one piece of sub-attribute information storing view information corresponding to one view object. Thereafter, the pieces of the sub-attribute information are compiled and wrapped respectively to generate corresponding sub-layout data objects, wherein the sub-layout data object is also a data object implemented based on the XMLBlock class, so that it can have the same data structure as the above layout data object but has a smaller data volume. Thereafter, a set of the plurality of sub-layout data objects is determined as a layout data object.

Exemplarily, FIG. 7 is a schematic diagram of generating sub-layout data objects provided in the embodiment. As shown in FIG. 7, after attribute information Info in a binary data format is obtained in accordance with the layout file, the attribute information Info is split into a plurality of pieces of sub-attribute information, for example, sub-attribute information Info_1, sub-attribute information Info_2, and sub-attribute information Info_3 shown in the figure, where each piece of the sub-attribute information respectively corresponds to one view object, for example, a view object corresponding to the sub-attribute information Info_1 is TextView (text box), a view object corresponding to the sub-attribute information Info_2 is LinearLayout (linear layout), and a view object corresponding to the sub-attribute information Info_3 is Button (button). Thereafter, each piece of the sub-attribute information is respectively wrapped and edited to generate a corresponding sub-layout data object which is based on XmlBlock, namely a sub-layout data object XB_1, a sub-layout data object XB_2 and a sub-layout data object XB_3. View information corresponding to the TextView is contained in the sub-layout data object XB_1; view information corresponding to the LinearLayout is contained in the sub-layout data object XB_2; and view information corresponding to the Button is contained in the sub-layout data object XB_3. Thereafter, a set of the sub layout data object XB_1, the sub layout data object XB_2, and the sub layout data object XB_3 is taken as a layout data object.

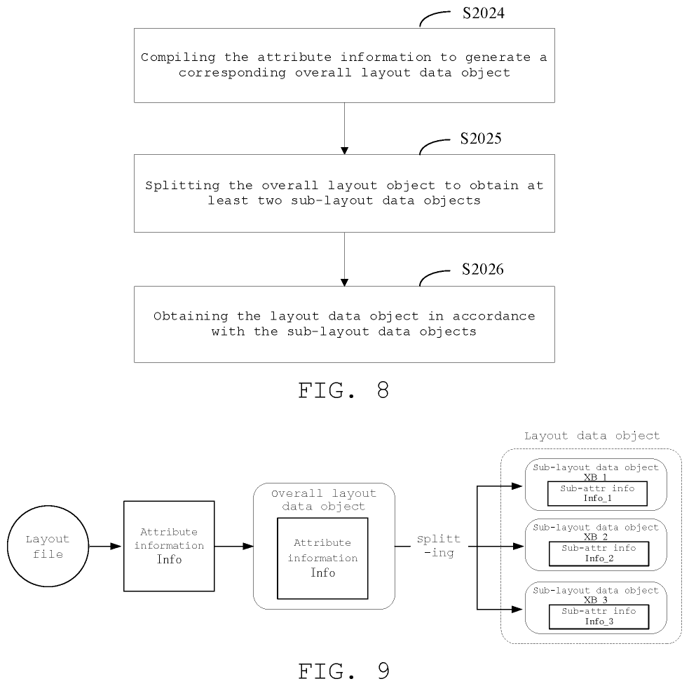

In another possible implementation, as shown in FIG. 8, another possible implementation of the step S202 includes:
step S2024: compiling the attribute information to generate a corresponding overall layout data object;
step S2025: splitting the overall layout object to obtain at least two sub-layout data objects;
step S2026: obtaining the layout data object in accordance with the sub-layout data objects.

Exemplarily, in another possible implementation, attribute information is compiled first to generate an overall layout data object corresponding to the attribute information, wherein the overall layout data object is also implemented based on XmlBlock, and the overall layout data object includes view information of view objects characterized by the attribute information. Thereafter, based on a preset parsing rule, the overall layout data object is split to obtain sub-layout data objects corresponding to view objects, wherein each of the sub-layout data objects has the same data structure as the layout data object but has a smaller data volume, and since it is the same as the sub-layout data object in the embodiment shown in FIG. 5, it is not repeated here. Thereafter, a layout data object is obtained in accordance with a set of the sub-layout data objects.

Exemplarily, FIG. 9 is another schematic diagram of generating sub-layout data objects provided in the embodiment. As shown in FIG. 9, after attribute information Info in a binary data format is obtained in accordance with the XML file, the attribute information Info is directly compiled and wrapped to generate an overall layout data object XBlock corresponding to the attribute information Info; the overall layout data object XBlock is implemented based on XmlBlock and has a first data format, and the overall layout data object XBlock includes complete information in the attribute information Info, which is equivalent to a format conversion of the attribute information Info. Thereafter, the layout data object XBlock is split into a plurality of sub-layout data objects, namely a sub-layout data object XB_1, a sub-layout data object XB_2, and a sub-layout data object XB_3, wherein exemplarily, view information corresponding to TextView is contained in the sub-layout data object XB_1; view information corresponding to LinearLayout is contained in the sub-layout data object XB_2; and view information corresponding to Button is contained in the sub-layout data object XB_3. Thereafter, a set of the sub-layout data object XB_1, the sub-layout data object XB_2, and the sub-layout data object XB_3 is taken as a layout data object. The splitting of the overall layout object may be specifically implemented through ResXMLTree, wherein, specifically, ResXMLTree is one object (ResXMLTree object) in a C++ layer, the ResXMLTree is created by calling a corresponding constructor, and the splitting of the overall layout object based on the XmlBlock structure is implemented through the ResXMLTree, and the specific implementations are not described here.

In the step of this embodiment, attribute information is directly compiled and wrapped to generate an overall layout data object, and then the overall layout data object is split to obtain a plurality of sub-layout data objects, thereby forming a layout data object, which avoids the problem of generating an intermediate layout (i.e. sub-attribute information) in an intermediate process, so that the speed of generating the layout data object is improved, and the purpose of improving the loading speed of the target page is finally achieved.

Step S203: obtaining the attribute parameter of the target constructor in accordance with the layout data object.

Step S204: constructing the target view object in accordance with the target constructor and the obtained attribute parameter of the target constructor, and displaying the target page based on the target view object.

Exemplarily, as can be seen from the previous steps, the obtained layout data object is formed by the plurality of sub-layout data objects, each of the sub-data objects storing view information of one view object. The layout data object with such a data structure (i.e., a first data structure) is taken as the attribute parameter AttributeSet of the target constructor, thus it is possible to call the target constructor, so that the data (view information of the view objects) in the layout data object is loaded into the target constructor, and then a plurality of corresponding target view objects, i.e., ViewTree, are constructed. Thereafter, content corresponding to the target view objects is rendered within the target page based on the ViewTree, and a specific rendering process is not described.

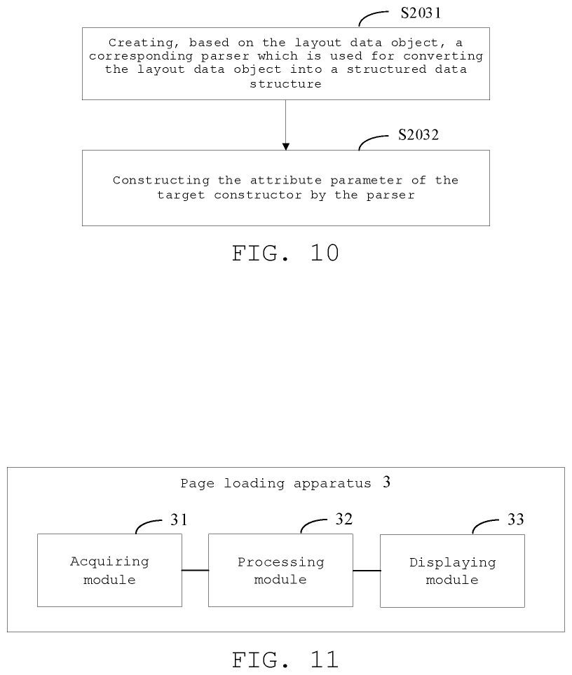

In one possible implementation, as shown in FIG. 10, a specific implementation of the step S203 comprises:
step S2031: creating, based on the layout data object, a corresponding parser which is used for converting the layout data object into a structured data structure; and
step S2032: constructing the attribute parameter of the target constructor by the parser.

Exemplarily, based on the above discussion of the layout data object, after a layout data object having a first data format is created, the layout data object is an XmlBlock-based object, so that by calling a parser construction method of XmlBlock, a corresponding parser can be created. Specifically, for example, by a newParser ( ) method of XmlBlock, a parser XmlBlock. Parser can be obtained. More specifically, the XmlBlock. Parser is one declarative XML parser that can help a developer convert a complex XML file into a structured data structure. It is a generic parser, can automatically recognize various XML elements, for example, elements, attributes, text nodes, etc., and convert them into readable strings or meaningful data objects. It may also support multiple XML types, such as XHTML and Atom recommended by W3C, as well as other third party formats. The XmlBlock. Parser also supports multiple languages including Java, C#, JavaScript, etc., and various platforms including Android, ios, Windows, etc. The specific principle of the XmlBlock. Parser is an existing technology, so that it will not be further described here.

Further, after the parser is obtained, an attribute parameter AttributeSet of a target constructor is constructed by the parser XmlBlock. Parser. Specifically, in the present embodiment, the attribute parameter is constructed by the parser, because: in order to acquire an attribute of a target view object View, Context#obtainStyledAttributes is to be called; in the process of step-by-step call, Resources Impl#obtainStyledAttributes will be finally called, and in a specific implementation of the Resources Impl#obtainStyledAttributes, there is one compulsion type conversion that the AttributeSet is compulsorily converted into the XmlBlock. Parser, that is, the attribute parameter AttributeSet is implemented based on the XmlBlock. Parser. Therefore, in the embodiment, the attribute parameter AttributeSet of the target constructor is constructed using the parser XmlBlock. Parser, so that the obtained attribute parameter AttributeSet can meet the calling condition of the target constructor and then the target view object is successfully generated.

In the embodiment, the steps S200 and S201 are consistent with the steps S101 and S102 in the above embodiment, and please refer to the discussion of the steps S101 and S102 in the embodiment shown in FIG. 2 for the details, which will not be repeated here.

Corresponding to the page loading method in the foregoing embodiment, FIG. 11 is a structural block diagram of a page loading apparatus provided in an embodiment of the present disclosure. For ease of illustration, only portions related to the embodiment of the present disclosure are shown. Referring to FIG. 11, the page loading apparatus 3 comprises:
an acquiring module 31 configured to acquire attribute information of a target page, which characterizes a page layout of the target page;
a processing module 32 configured to obtain, in accordance with the attribute information, a corresponding target constructor which has an attribute parameter for receiving the attribute information; and
a displaying module 33 configured to construct a target view object in accordance with the target constructor and the attribute information, and display the target page based on the target view object.

In one embodiment of the present disclosure, the attribute parameter is a custom attribute AttributeSet.

In one embodiment of the present disclosure, the processing module 32 is further configured to: create, in accordance with the attribute information, a layout data object with a first data format, which is used for characterizing an overall layout of view objects within the target page; and obtain the attribute parameter of the target constructor in accordance with the layout data object; and the displaying module 33 is specifically configured to: construct the target view object in accordance with the target constructor and the attribute parameter of the target constructor.

In one embodiment of the present disclosure, when obtaining the attribute parameter of the target constructor in accordance with the layout data object, the processing module 32 is specifically configured to: create, based on the layout data object, a corresponding parser which is used for converting the layout data object into a structured data structure; and construct the attribute parameter of the target constructor by the parser.

In one embodiment of the present disclosure, when creating, in accordance with the attribute information, a layout data object with a first data format, the processing module 32 is specifically configured to: split the attribute information to obtain at least two pieces of sub-attribute information, each piece of which characterizes an attribute of one of the view objects within the target page; compile the pieces of the sub-attribute information to generate corresponding sub-layout data objects; and obtain the layout data object in accordance with the sub-layout data objects.

In one embodiment of the present disclosure, when creating, in accordance with the attribute information, a layout data object with a first data format, the processing module 32 is specifically configured to: compile the attribute information to generate a corresponding overall layout data object; split the overall layout object to obtain at least two sub-layout data objects; and obtain the layout data object in accordance with the sub-layout data objects.

In one embodiment of the present disclosure, the target constructor further has a page parameter which is used for indicating the target page.

In one embodiment of the present disclosure, before the acquiring attribute information of a target page, the acquiring module is further configured to: acquire a layout file corresponding to the target page; and perform a file compilation on the layout file based on a preset parsing tool to obtain the attribute information of the target page, wherein the parsing tool is an Android Asset Packaging Tool aapt.

The acquiring module 31, the processing module 32, and the displaying module 33 are connected in sequence. The page loading apparatus 3 provided in this embodiment can perform the technical solution of the foregoing method embodiments, and has similar implementation principles and technical effects, which will not be repeated here in this embodiment.

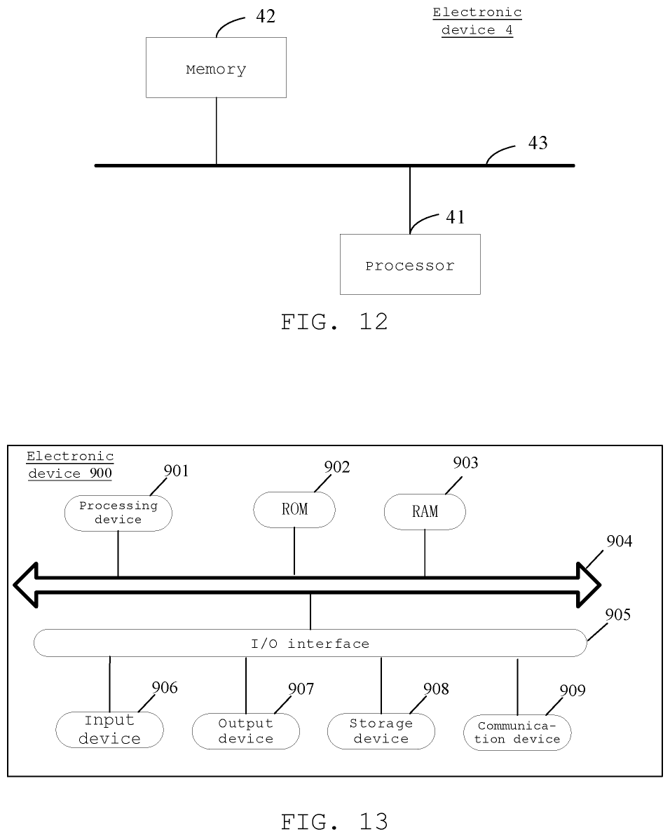

FIG. 12 is a schematic structural diagram of an electronic device provided in an embodiment of the present disclosure, and as shown in FIG. 12, the electronic device 4 comprises:
a processor 41, and a memory 42 communicatively connected with the processor 41,
wherein the memory 42 stores computer executable instructions; and
the processor 41 executes the computer executable instructions stored in the memory 42 to implement the page loading method in the embodiments shown in FIGS. 2 to 10.

Optionally, the processor 41 and the memory 42 are connected through a bus 43.

Relevant descriptions may be understood by correspondingly referring to relevant descriptions and effects corresponding to the steps in the embodiments corresponding to FIG. 2 to FIG. 10, and thus are not repeated here.

An embodiment of the present disclosure provides a computer-readable storage medium having therein stored computer executable instructions which, when executed by a processor, implement the page loading method provided in any of the embodiments corresponding to FIG. 2 to FIG. 10 of the present disclosure.

An embodiment of the present disclosure provides a computer program product comprising a computer program which, when executed by a processor, implements the page loading method in the embodiments shown in FIG. 2 to FIG. 10.

Reference is made to FIG. 13, which illustrates a structural schematic diagram of an electronic device 900 suitable for implementing an embodiment of the present disclosure, wherein the electronic device 900 may be a terminal device or a server. The terminal device may include, but is not limited to, a mobile terminal such as a mobile phone, a notebook computer, a digital broadcast receiver, a personal digital assistant (PDA), a portable android device (short for PAD), a portable multimedia player (PMP), and a vehicle-mounted terminal (e.g., a vehicle-mounted navigation terminal), and a fixed terminal such as a digital TV and a desktop computer. The electronic device shown in FIG. 13 is only an example, and should not bring any limitation to the functions and the scopes of use of the embodiments of the present disclosure.

As shown in FIG. 13, the electronic device 900 may comprise a processing device (e.g., a central processing unit, a graphics processing unit, etc.) 901, which may perform various suitable actions and processes in accordance with a program stored in a read-only memory (ROM) 902 or a program loaded from a storage device 908 into a random access memory (short for RAM) 903. In the RAM 903, various programs and data required for the operation of the electronic device 900 are also stored. The processing device 901, ROM 902, and RAM 903 are connected to each other via a bus 904. An input/output (I/O) interface 905 is also connected to the bus 904.

Generally, the following devices may be connected to the I/O interface 905: an input device 906 including, for example, a touch screen, touch pad, keyboard, mouse, camera, microphone, accelerometer, gyroscope, etc.; an output device 907 including, for example, a liquid crystal display (LCD), speaker, vibrator, etc.; the storage device 908 including, for example, a magnetic tape, hard disk, etc.; and a communication device 909. The communication device 909 may allow the electronic device 900 to communicate with other devices wirelessly or by wire to exchange data. While FIG. 13 illustrates the electronic device 900 having various devices, it should be understood that not all illustrated devices are required to be implemented or provided. More or fewer devices may be alternatively implemented or provided.

In particular, in accordance with the embodiments of the present disclosure, the processes described above with reference to the flow diagrams may be implemented as a computer software program. For example, an embodiment of the present disclosure comprises a computer program product, which comprises a computer program carried on a computer-readable medium, the computer program comprising program code for performing the method illustrated by the flow diagrams. In such an embodiment, the computer program may be downloaded and installed from a network through the communication device 909, or installed from the storage device 908, or installed from the ROM 902. The computer program, when executed by the processing device 901, performs the above functions defined in the method of the embodiments of the present disclosure.

It should be noted that the above computer-readable medium of the present disclosure may be a computer-readable signal medium or a computer-readable storage medium or any combination of the above two. The computer-readable storage medium may be, for example, but is not limited to, an electronic, magnetic, optical, electromagnetic, infrared, or semiconductor system, apparatus, or device, or any combination of the foregoing. More specific examples of the computer-readable storage medium may include, but are not limited to: an electrical connection having one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In the present disclosure, the computer-readable storage medium may be any tangible medium containing or storing a program, wherein the program can be used by or in conjunction with an instruction execution system, apparatus, or device. However, in the present disclosure, the computer-readable signal medium may include a data signal propagated in baseband or as part of a carrier wave, in which computer-readable program code is carried. Such a propagated data signal may take a variety of forms, including, but not limited to, an electromagnetic signal, optical signal, or any suitable combination of the forgoing. The computer-readable signal medium may also be any computer-readable medium other than the computer-readable storage medium, wherein the computer-readable signal medium can send, propagate, or transmit a program for use by or in conjunction with an instruction execution system, apparatus, or device. The program code contained on the computer-readable medium may be transmitted using any appropriate medium, including but not limited to: a wire, an optical cable, RF (Radio Frequency), etc., or any suitable combination of the foregoing.

The above computer-readable medium may be contained in the above electronic device; or may exist separately without being assembled into the electronic device.

The above computer-readable medium has one or more programs carried thereon, which, when executed by the electronic device, cause the electronic device to perform the methods shown in the above embodiments.

Computer program code for performing the operation of the present disclosure may be written in one or more programming languages or a combination thereof, and the above programming language includes an object-oriented programming language such as Java, Smalltalk, and C++, and also includes a conventional procedural programming language, such as a “C” language or a similar programming language. The program code may be executed entirely on a user's computer, partly on the user's computer, as a stand-alone software package, partly on the user's computer and partly on a remote computer, or entirely on the remote computer or server. In a scenario where the remote computer is involved, the remote computer may be connected to the user's computer through any type of network, including a local area network (short for LAN) or a wide area network (short for WAN), or may be connected to an external computer (for example, through the Internet using an Internet service provider).

The flow diagrams and block diagrams in the drawings illustrate the possibly implemented architecture, functions, and operations of the system, method and computer program product in accordance with various embodiments of the present disclosure. In this regard, each block in the flow diagrams or block diagrams may represent a module, program segment, or part of code, which includes one or more executable instructions for implementing a specified logical function. It should also be noted that, in some alternative implementations, functions noted in blocks may occur in a different order from those noted in the drawings. For example, two blocks shown in succession may, in fact, be executed substantially concurrently, or they may sometimes be executed in a reverse order, which depends upon the functions involved. It will also be noted that each block in the block diagrams and/or flow diagrams, and a combination of the blocks in the block diagrams and/or flow diagrams, can be implemented by a special-purpose hardware-based system that performs specified functions or operations, or a combination of special-purpose hardware and computer instructions.

The involved unit described in the embodiments of the present disclosure may be implemented by software or hardware. The name of the unit does not, in some cases, constitute a limitation on the unit itself, for example, for example, a first acquiring unit may also be described as “a unit configured to acquire at least two Internet protocol addresses”.

The functions described above herein may be executed, at least partially, by one or more hardware logic components. For example, without limitation, an exemplary type of hardware logic component that may be used includes: a field programmable gate array (FPGA), an application specific integrated circuit (ASIC), an application specific standard product (ASSP), a system on chip (SOC), a complex programmable logic device (CPLD), and the like.

In the context of this disclosure, a machine-readable medium may be a tangible medium, which can contain, or store a program for use by or in conjunction with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or y suitable combination of the foregoing. More specific examples of the machine-readable storage medium include an electrical connection based on one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing.

In a first aspect, in accordance with one or more embodiments of the present disclosure, there is provided a page loading method, comprising:
acquiring attribute information of a target page, which characterizes a page layout of the target page; obtaining, in accordance with the attribute information, a corresponding target constructor which has an attribute parameter for receiving the attribute information; and constructing a target view object in accordance with the target constructor and the attribute information, and displaying the target page based on the target view object.

In accordance with one or more embodiments of the present disclosure, the target constructor is a constructor of a view object, the attribute parameter of the target constructor is a custom attribute.

In accordance with one or more embodiments of the present disclosure, the method further comprises: creating, in accordance with the attribute information, a layout data object with a first data format, which is used for characterizing an overall layout of view objects within the target page; and obtaining the attribute parameter of the target constructor in accordance with the layout data object; and wherein the constructing a target view object in accordance with the target constructor and the attribute information comprises: constructing the target view object in accordance with the target constructor and the obtained attribute parameter of the target constructor.

In accordance with one or more embodiments of the present disclosure, the obtaining the attribute parameter of the target constructor in accordance with the layout data object comprises: creating, based on the layout data object, a corresponding parser which is used for converting the layout data object into a structured data structure; and constructing the attribute parameter of the target constructor by the parser.

In accordance with one or more embodiments of the present disclosure, the creating, in accordance with the attribute information, a layout data object with a first data format comprises: splitting the attribute information to obtain at least two pieces of sub-attribute information, each piece of which characterizes an attribute of one of the view objects within the target page; compiling the pieces of the sub-attribute information to generate corresponding sub-layout data objects; and obtaining the layout data object in accordance with the sub-layout data objects.

In accordance with one or more embodiments of the present disclosure, the creating, in accordance with the attribute information, a layout data object with a first data format comprises: compiling the attribute information to generate a corresponding overall layout data object; splitting the overall layout object to obtain at least two sub-layout data objects; and obtaining the layout data object in accordance with the sub-layout data objects.

In accordance with one or more embodiments of the present disclosure, the target constructor further has a page parameter which is used for indicating the target page.

In accordance with one or more embodiments of the present disclosure, before the acquiring attribute information of a target page, the method further comprises: acquiring a layout file corresponding to the target page; and performing a file compilation on the layout file based on a preset parsing tool to obtain the attribute information of the target page, wherein the parsing tool is an Android Asset Packaging Tool aapt.

In a second aspect, in accordance with one or more embodiments of the present disclosure, there is provided a page loading apparatus, comprising:
an acquiring module configured to acquire attribute information of a target page, which characterizes a page layout of the target page;
a processing module configured to obtain, in accordance with the attribute information, a corresponding target constructor which has an attribute parameter for receiving the attribute information; and
a displaying module configured to construct a target view object in accordance with the target constructor and the attribute information, and display the target page based on the target view object.

In accordance with one or more embodiments of the present disclosure, the target constructor is a constructor of a view object, the attribute parameter of the target constructor is a custom attribute.

In accordance with one or more embodiments of the present disclosure, the processing module is further configured to: create, in accordance with the attribute information, a layout data object with a first data format, which is used for characterizing an overall layout of view objects within the target page; and obtain the attribute parameter of the target constructor in accordance with the layout data object; and the displaying module is specifically configured to: construct the target view object in accordance with the target constructor and the obtained attribute parameter of the target constructor.

In accordance with one or more embodiments of the present disclosure, when obtaining the attribute parameter of the target constructor in accordance with the layout data object, the processing module is specifically configured to: create, based on the layout data object, a corresponding parser which is used for converting the layout data object into a structured data structure; and construct the attribute parameter of the target constructor by the parser.

In accordance with one or more embodiments of the present disclosure, when creating, in accordance with the attribute information, a layout data object with a first data format, the processing module is specifically configured to: split the attribute information to obtain at least two pieces of sub-attribute information, each piece of which characterizes an attribute of one of the view objects within the target page; compile the pieces of the sub-attribute information to generate corresponding sub-layout data objects; and obtain the layout data object in accordance with the sub-layout data objects.

In accordance with one or more embodiments of the present disclosure, when creating, in accordance with the attribute information, a layout data object with a first data format, the processing module is specifically configured to: compile the attribute information to generate a corresponding overall layout data object; split the overall layout object to obtain at least two sub-layout data objects; and obtain the layout data object in accordance with the sub-layout data objects.

In accordance with one or more embodiments of the present disclosure, the target constructor further has a page parameter which is used for indicating the target page.

In accordance with one or more embodiments of the present disclosure, before the acquiring attribute information of a target page, the acquiring module is further configured to: acquire a layout file corresponding to the target page; and perform a file compilation on the layout file based on a preset parsing tool to obtain the attribute information of the target page, wherein the parsing tool is an Android Asset Packaging Tool aapt.

In a third aspect, in accordance with one or more embodiments of the present disclosure, there is provided an electronic device, comprising:
a processor, and a memory communicatively connected with the processor;
wherein the memory stores computer executable instructions, and
the processor executes the computer executable instructions stored in the memory, to implement the page loading method in accordance with the first aspect and various possible designs of the first aspect.

In a fourth aspect, in accordance with one or more embodiments of the present disclosure, there is provided a non-transitory computer-readable storage medium having therein stored computer executable instructions which, when executed by a processor, implement the page loading method in accordance with the first aspect and various possible designs of the first aspect.

In a fifth aspect, an embodiment of the present disclosure provides a computer program product comprising a computer program which, when executed by a processor, implements the page loading method in accordance with the first aspect and various possible designs of the first aspect.

The foregoing only describes the preferred embodiments of the present disclosure and the technical principles employed. It should be appreciated by those skilled in the art that, the disclosure scope involved in the present disclosure is not limited to the technical solutions formed by specific combinations of the technical features described above, but also encompasses other technical solutions formed by arbitrary combinations of the above technical features or equivalent features thereof without departing from the above disclosed concepts, for example, a technical solution formed by performing mutual replacement between the above features and technical features having similar functions disclosed (but not limited to) in the present disclosure.

Furthermore, while operations are depicted in a specific order, this should not be understood as requiring that these operations be performed in the specific order shown or in a sequential order. Under certain circumstances, multitasking and parallel processing might be advantageous. Similarly, while several specific implementation details are included in the above discussion, these should not be construed as limitations on the scope of the present disclosure. Certain features that are described in the context of separate embodiments may also be implemented in combination in a single embodiment. Conversely, various features that are described in the context of a single embodiment may also be implemented in multiple embodiments separately or in any suitable sub-combination.

Although the subject matter has been described in language specific to structural features and/or method logical actions, it should be understood that the subject matter defined in the attached claims is not necessarily limited to the specific features or actions described above. Rather, the specific features and actions described above are only example forms of implementing the claims.

1. A page loading method, comprising:
acquiring attribute information of a target page, which characterizes a page layout of the target page;
obtaining, in accordance with the attribute information, a corresponding target constructor which has an attribute parameter for receiving the attribute information; and
constructing a target view object in accordance with the target constructor and the attribute information, and displaying the target page based on the target view object.

2. The method according to claim 1, wherein the target constructor is a constructor of a view object, and the attribute parameter of the target constructor is a custom attribute.

3. The method according to claim 1, wherein the method further comprises:
creating, in accordance with the attribute information, a layout data object with a first data format, which is used for characterizing an overall layout of view objects within the target page; and
obtaining the attribute parameter of the target constructor in accordance with the layout data object; and
wherein the constructing a target view object in accordance with the target constructor and the attribute information comprises:
constructing the target view object in accordance with the target constructor and the obtained attribute parameter of the target constructor.

4. The method according to claim 3, wherein the obtaining the attribute parameter of the target constructor in accordance with the layout data object comprises:
creating, based on the layout data object, a corresponding parser which is used for converting the layout data object into a structured data structure; and
constructing the attribute parameter of the target constructor by the parser.

5. The method according to claim 3, wherein the creating, in accordance with the attribute information, a layout data object with a first data format comprises:
splitting the attribute information to obtain at least two pieces of sub-attribute information, each piece of which characterizes an attribute of one of the view objects within the target page;
compiling the pieces of the sub-attribute information to generate corresponding sub-layout data objects; and
obtaining the layout data object in accordance with the sub-layout data objects.

6. The method according to claim 3, wherein the creating, in accordance with the attribute information, a layout data object with a first data format comprises:
compiling the attribute information to generate a corresponding overall layout data object;
splitting the overall layout object to obtain at least two sub-layout data objects; and
obtaining the layout data object in accordance with the sub-layout data objects.

7. The method according to claim 1, wherein the target constructor further has a page parameter which is used for indicating the target page.

8. The method according to claim 1, wherein before the acquiring attribute information of a target page, the method further comprises:
acquiring a layout file corresponding to the target page; and
performing a file compilation on the layout file based on a preset parsing tool to obtain the attribute information of the target page,
wherein the parsing tool is an Android Asset Packaging Tool aapt.

9. An electronic device, comprising: a processor, and a memory communicatively connected with the processor,
wherein the memory stores computer executable instructions, and
the processor executes the computer executable instructions stored in the memory to implement the following operations for page loading:
acquiring attribute information of a target page, which characterizes a page layout of the target page;
obtaining, in accordance with the attribute information, a corresponding target constructor which has an attribute parameter for receiving the attribute information; and
constructing a target view object in accordance with the target constructor and the attribute information, and displaying the target page based on the target view object.

10. The electronic device according to claim 9, wherein the target constructor is a constructor of a view object, and the attribute parameter of the target constructor is a custom attribute.

11. The electronic device according to claim 9, wherein the processor executes the computer executable instructions stored in the memory to further implement the following operations for page loading:
creating, in accordance with the attribute information, a layout data object with a first data format, which is used for characterizing an overall layout of view objects within the target page; and
obtaining the attribute parameter of the target constructor in accordance with the layout data object; and
wherein the constructing a target view object in accordance with the target constructor and the attribute information comprises:
constructing the target view object in accordance with the target constructor and the obtained attribute parameter of the target constructor.

12. The electronic device according to claim 11, wherein the obtaining the attribute parameter of the target constructor in accordance with the layout data object comprises:
creating, based on the layout data object, a corresponding parser which is used for converting the layout data object into a structured data structure; and
constructing the attribute parameter of the target constructor by the parser.

13. The electronic device according to claim 11, wherein the creating, in accordance with the attribute information, a layout data object with a first data format comprises:
splitting the attribute information to obtain at least two pieces of sub-attribute information, each piece of which characterizes an attribute of one of the view objects within the target page;
compiling the pieces of the sub-attribute information to generate corresponding sub-layout data objects; and
obtaining the layout data object in accordance with the sub-layout data objects.

14. The electronic device according to claim 11, wherein the creating, in accordance with the attribute information, a layout data object with a first data format comprises:
compiling the attribute information to generate a corresponding overall layout data object;
splitting the overall layout object to obtain at least two sub-layout data objects; and
obtaining the layout data object in accordance with the sub-layout data objects.

15. A non-transitory computer-readable storage medium, having therein stored computer executable instructions which, when executed by a processor, implement the following operations for page loading:
acquiring attribute information of a target page, which characterizes a page layout of the target page;
obtaining, in accordance with the attribute information, a corresponding target constructor which has an attribute parameter for receiving the attribute information; and
constructing a target view object in accordance with the target constructor and the attribute information, and displaying the target page based on the target view object.

16. The storage medium according to claim 15, wherein the target constructor is a constructor of a view object, and the attribute parameter of the target constructor is a custom attribute.

17. The storage medium according to claim 15, wherein the computer executable instructions, when executed by the processor, further implement the following operations for page loading:
creating, in accordance with the attribute information, a layout data object with a first data format, which is used for characterizing an overall layout of view objects within the target page; and
obtaining the attribute parameter of the target constructor in accordance with the layout data object; and
wherein the constructing a target view object in accordance with the target constructor and the attribute information comprises:
constructing the target view object in accordance with the target constructor and the obtained attribute parameter of the target constructor.

18. The storage medium according to claim 17, wherein the obtaining the attribute parameter of the target constructor in accordance with the layout data object comprises:
creating, based on the layout data object, a corresponding parser which is used for converting the layout data object into a structured data structure; and
constructing the attribute parameter of the target constructor by the parser.

19. The storage medium according to claim 17, wherein the creating, in accordance with the attribute information, a layout data object with a first data format comprises:
splitting the attribute information to obtain at least two pieces of sub-attribute information, each piece of which characterizes an attribute of one of the view objects within the target page;
compiling the pieces of the sub-attribute information to generate corresponding sub-layout data objects; and
obtaining the layout data object in accordance with the sub-layout data objects.

20. The storage medium according to claim 17, wherein the creating, in accordance with the attribute information, a layout data object with a first data format comprises:
compiling the attribute information to generate a corresponding overall layout data object;
splitting the overall layout object to obtain at least two sub-layout data objects; and
obtaining the layout data object in accordance with the sub-layout data objects.
